(19) United States
(12) Patent Application Publication
(10) Pub. No.: US 2023/0216323 A1
(43) Pub. Date: Jul. 6, 2023

(54) SUPERCAPACITOR TO ELECTROCHEMICAL HYBRID CHARGING SYSTEM

(71) Applicant: SUSTAINABLE ENERGY TECHNOLOGIES, INC., Wilmington, DE (US)

(72) Inventor: John Cronin, Wilmington, DE (US)

(21) Appl. No.: 18/088,256

(22) Filed: Dec. 23, 2022

Related U.S. Application Data
(60) Provisional application No. 63/295,420, filed on Dec. 30, 2021.

(51) Int. Cl. H02J 7/00; B60L 15/20; B60L 50/40; H02J 3/32; H02J 7/34

(52) U.S. Cl. CPC H02J 7/0071; B60L 15/2045; B60L 50/40; H02J 3/322; H02J 7/0068; H02J 7/345; H02J 2207/50; H02J 2310/48

(57) ABSTRACT

A system for powering an electric vehicle includes at least one electrochemical battery, a supercapacitor adder module including at least one supercapacitor battery, and a controller configured, in response to detecting that an external charging source is connected to the supercapacitor adder module, to disconnect the at least one electrochemical battery from the electric vehicle, charge the at least one supercapacitor battery from the external charging source via the supercapacitor adder module, charge the at least one electrochemical battery from the external charging source via the supercapacitor adder module, and reconnect the at least one electrochemical battery to the electric vehicle.

### CROSS-REFERENCE TO RELATED APPLICATIONS

This application claims the benefit of Provisional Application No. 63/295,420, filed Dec. 30, 2021, for “SUPERCAPACITOR TO ELECTROCHEMICAL HYBRID CHARGING SYSTEM,” the disclosure of which is incorporated herein by reference in its entirety.

### TECHNICAL FIELD

The present disclosure is generally related to batteries for electric vehicles and, more particularly, to a hybrid charging system for an electrical vehicle incorporating supercapacitor and electrochemical batteries.

### BACKGROUND

The subject matter discussed in the background section should not be assumed to be prior art merely due to its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The number of electric vehicles (EVs) in operation has grown exponentially in recent years. Conventionally, EVs have relied on electrochemical batteries, e.g., lithium-ion and lead-acid batteries. However, electrochemical batteries suffer from a variety of disadvantages including a short shelf-life, low peak power, and a limited number of charging/discharging cycles.

Supercapacitors are like a hybrid of an electrochemical battery and a standard capacitor. Supercapacitors can hold a significantly greater electrical charge than a standard capacitor and can be recharged many more times than electrochemical batteries. Electrochemical batteries have less energy density than supercapacitors. Energy density is measured by the energy produced divided by the weight of the battery.

Supercapacitors discharge faster than electrochemical batteries, as supercapacitors cannot hold power for a long time. Supercapacitors will discharge up to 20% more power per day than batteries of equal capacity. Supercapacitors have a fast discharged time but also have fast charging time. Electrochemical batteries take longer to charge but discharge more slowly, so they don't have to be charged as frequently as supercapacitors. Electrochemical batteries are ideal for long-term power storage needs because they discharge electricity less quickly.

Supercapacitors have a longer lifespan than electrochemical batteries. Some supercapacitors can be charged millions of times before they start to degrade. By contrast, electrochemical batteries, like lead-acid batteries, may only provide 500 to 1,000 charge cycles before they degrade.

There is a need to reduce the number of charging cycles of electrochemical batteries while providing greater electrical charge in electric vehicles. There is also a need optimize the charging of electrochemical batteries in an electric vehicle while enhancing the useful life of the electrochemical batteries.

### SUMMARY OF THE DISCLOSURE

According to one aspect, a method is provided for powering an electric vehicle including at least one electrochemical battery and a supercapacitor adder module including at least one supercapacitor battery. The method includes, in response to detecting that an external charging source is connected to the supercapacitor adder module, disconnecting the at least one electrochemical battery from the electric vehicle, charging the at least one supercapacitor battery from the external charging source via the supercapacitor adder module, charging the at least one electrochemical battery from the external charging source via the supercapacitor adder module, and reconnecting the at least one electrochemical battery to the electric vehicle. The method also includes determining, based on a usage pattern of the at least one electrochemical battery, whether to switch from the at least one electrochemical battery to the at least one supercapacitor battery for powering the electric vehicle, and, in response to a determination to switch from the at least one electrochemical battery to the at least one supercapacitor battery, disconnecting the at least one electrochemical battery from the electric vehicle and connecting the at least one supercapacitor battery to power to the electric vehicle.

In one embodiment, charging the at least one supercapacitor battery from the external charging source via the supercapacitor adder module includes reading a database to determine a maximum capacity of the at least one supercapacitor battery, connecting the external charging source to the at least one supercapacitor battery through a connection within the supercapacitor adder module, and charging the at least one supercapacitor battery to at least a threshold percentage of the maximum capacity. In one embodiment, charging may further include sending an alert to a user that the at least one supercapacitor battery is being charged and/or sending an alert to the user that charging of the at least one supercapacitor battery is complete.

In one embodiment, charging the at least one electrochemical battery from the external charging source via the supercapacitor adder module includes connecting the external charging source to the at least one electrochemical battery through a connection within the supercapacitor adder module and allowing a battery management system of the external charging source to charge the at least one electrochemical battery. In one embodiment, charging the at least one supercapacitor battery takes place before charging the at least one electrochemical battery.

In one embodiment, determining, based on the usage pattern of the at least one electrochemical battery, whether to switch from the at least one electrochemical battery to the at least one supercapacitor battery for powering the electric vehicle includes measuring, by at least one current tester, current flow between the at least one electrochemical battery and the electric vehicle, storing indications of the current flow in a database, and using the indications of the current flow in the database to determine the usage pattern. In one embodiment, the usage pattern includes whether the current flow either meets or exceeds a threshold value.

In one embodiment, the method further includes determining, based on a usage pattern of the at least one supercapacitor battery, whether to switch from the at least one supercapacitor battery to the at least one electrochemical battery for powering the electric vehicle and, in response to a determination to switch from the at least one supercapacitor battery to the at least one electrochemical battery, disconnecting the at least one supercapacitor battery from the electric vehicle and connecting the at least one electrochemical battery to power the electric vehicle.

In one embodiment, determining, based on the usage pattern of the at least one supercapacitor battery, whether to switch from the at least one supercapacitor battery to the at least one electrochemical battery for powering the electric vehicle includes measuring, by at least one current tester, current flow between the at least one supercapacitor battery and the electric vehicle and storing indications of the current flow in a database and using the indications of the current flow in the database to determine the usage pattern.

According to another aspect, a system is provided for powering an electric vehicle. The system includes at least one electrochemical battery, a supercapacitor adder module including at least one supercapacitor battery, and a controller configured, in response to detecting that an external charging source is connected to the supercapacitor adder module, to disconnect the at least one electrochemical battery from the electric vehicle, charge the at least one supercapacitor battery from the external charging source via the supercapacitor adder module, charge the at least one electrochemical battery from the external charging source via the supercapacitor adder module, and reconnect the at least one electrochemical battery to the electric vehicle. The controller is also configured to determine, based on a usage pattern of the at least one electrochemical battery, whether to switch from the at least one electrochemical battery to the at least one supercapacitor battery for powering the electric vehicle and, in response to a determination to switch from the at least one electrochemical battery to the at least one supercapacitor battery, disconnect the at least one electrochemical battery from the electric vehicle and connect the at least one supercapacitor battery to power to the electric vehicle.

In one embodiment, the controller, when charging the at least one supercapacitor battery from the external charging source via the supercapacitor adder module, is configured to read a database to determine a maximum capacity of the at least one supercapacitor battery, connect the external charging source to the at least one supercapacitor battery through a connection within the supercapacitor adder module, and charge the at least one supercapacitor battery to at least a threshold percentage of the maximum capacity.

In one embodiment, the controller, when charging the at least one supercapacitor battery from the external charging source via the supercapacitor adder module, is configured to send an alert to a user that the at least one supercapacitor battery is being charged and/or that charging of the at least one supercapacitor battery is complete.

In one embodiment, the controller, when charging the at least one electrochemical battery from the external charging source via the supercapacitor adder module, is configured to connect the external charging source to the at least one electrochemical battery through a connection within the supercapacitor adder module and allow a battery management system of the external charging source to charge the at least one electrochemical battery.

In one embodiment, the controller, when determining, based on the usage pattern of the at least one electrochemical battery, whether to switch from the at least one electrochemical battery to the at least one supercapacitor battery for powering the electric vehicle, is configured to measure, by at least one current tester, a current flow between the at least one electrochemical battery and the electric vehicle, store indications of the current flow in a database, and use the indications of the current flow in the database to determine the usage pattern. In one embodiment, the usage pattern includes whether the current flow either meets or exceeds a threshold value.

In one embodiment, the controller is further configured to determine, based on a usage pattern of the at least one supercapacitor battery, whether to switch from the at least one supercapacitor battery to the at least one electrochemical battery for powering the electric vehicle and, in response to a determination to switch from the at least one supercapacitor battery to the at least one electrochemical battery, disconnect the at least one supercapacitor battery from the electric vehicle and connect the at least one electrochemical battery to power the electric vehicle.

In one embodiment, the controller, when determining, based on the usage pattern of the at least one supercapacitor battery, whether to switch from the at least one supercapacitor battery to the at least one electrochemical battery for powering the electric vehicle is configured to measure, by at least one current tester, current flow between the at least one supercapacitor battery and the electric vehicle, store indications of the current flow in a database, and use the indications of the current flow in the database to determine the usage pattern.

### BRIEF DESCRIPTION OF THE DRAWINGS

The accompanying drawings illustrate various embodiments of systems, methods, and other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 is a schematic diagram of a hybrid charging system for an electric vehicle according to an embodiment.

FIG. 2 is a flowchart of a method performed by a supercapacitor controller according to an embodiment.

FIG. 3 is a flowchart of a method performed by a base module according to an embodiment.

FIG. 4 is a flowchart of a method performed by a charger module according to an embodiment.

FIG. 5 is a flowchart of a method for powering an electric vehicle according to an embodiment.

### DETAILED DESCRIPTION

Aspects of the present invention are disclosed in the following description and related figures directed to specific embodiments of the invention. Those of ordinary skill in the art will recognize that alternate embodiments may be devised without departing from the claims' spirit or scope. Additionally, well-known elements of exemplary embodiments of the invention will not be described in detail or will be omitted so as not to obscure the relevant details of the invention

As used herein, the word exemplary means serving as an example, instance, or illustration. The embodiments described herein are not limiting but rather are exemplary only. It should be understood that the described embodiments are not necessarily to be construed as preferred or advantageous over other embodiments. Moreover, the terms embodiments of the invention, embodiments, or invention do not require that all embodiments include the discussed feature, advantage, or mode of operation.

Further, many of the embodiments are described in sequences of actions to be performed by, for example, elements of a computing device. It should be recognized by those skilled in the art that specific circuits can perform the various sequence of actions described herein (e.g., application-specific integrated circuits or “ASICs”) and/or by program instructions executed by at least one processor. Additionally, the sequence of actions described herein can be embodied entirely within any form of computer-readable storage medium. The execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

For all ranges given herein, it should be understood that any lower limit may be combined with any upper limit when feasible. Thus, for example, citing a temperature range of from 5° C. to ° C. and from 20° C. to 200° C. would also inherently include a range of from 5° C. to 200° C. and a range of 20° C. to ° C.

When listing various aspects of the products, methods, or system described herein, it should be understood that any feature, element, or limitation of one aspect, example, or claim may be combined with any other feature, element, or limitation of any other aspect when feasible (i.e., not contradictory). Thus, disclosing an example of a power pack comprising a temperature sensor and then a different example of a power pack associated with an accelerometer would inherently disclose a power pack comprising or associated with an accelerometer and a temperature sensor.

Unless otherwise indicated, components such as software modules or other modules may be combined into a single module or component or divided. The function involves the cooperation of two or more components or modules. Identifying an operation or feature as a single discrete entity should be understood to include division or combination such that the effect of the identified component is still achieved.

Some embodiments of this disclosure, illustrating its features, will now be discussed in detail. It can be understood that the embodiments are intended to be open-ended in that an item or items used in the embodiments is not meant to be an exhaustive listing of such items or items or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used to practice or test embodiments, only some exemplary systems and methods are now described.

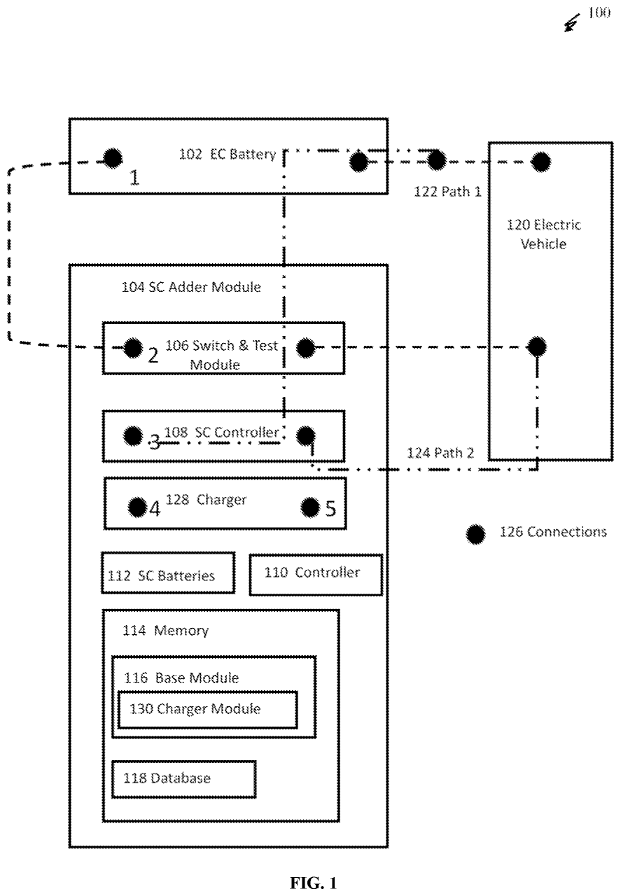

FIG. 1 is a schematic block diagram of a hybrid power system 100 according to one embodiment. The system 100 may include an electrochemical (EC) battery 102, such as a lead-acid battery or a lithium-ion battery. While the disclosure often refers to a singular electrochemical battery 102, it should be understood that any such reference is understood to include one or more electrochemical batteries 102. The electrochemical battery 102 may be an existing electrochemical battery 102 within an electric vehicle 120 or may be in addition to an existing electrochemical battery 102 or battery system.

The system 100 may further include a supercapacitor (SC) adder module 104, which may be embodied as a self-contained unit with various connections 126. Although six connections 126 are illustrated in FIG. 1, a person of skill in the art will recognize that more or fewer connections 126 may be provided. The supercapacitor adder module 104 may include one or more supercapacitor batteries 112. While the present disclosure often refers to the supercapacitor batteries 112 in the plural, it should be understood that any such reference is understood to include one or more supercapacitor batteries 112 or groups of supercapacitor cells.

As described in greater detail below, the supercapacitor adder module 104 may also include a control system to automatically switch between the electrochemical battery 102 and the supercapacitor batteries 112 (or vice versa) when powering the electric vehicle 120. In one embodiment, the supercapacitor adder module 104 including the supercapacitor batteries 112 has a higher capacity than a traditional electrochemical battery 102 and delivers a greater charge at a smaller weight and size. The supercapacitor batteries 112 may include any type or configuration of supercapacitor batteries or cells having enough capacity to enhance the integration of the supercapacitor adder module 104 and the electrochemical battery 102. The supercapacitor batteries 112 may be configured to have the same voltage as the electrochemical battery 102 so to easily integrate into the electric vehicle 120.

Principles for the design, manufacture, and operation of supercapacitors are described, by way of example, in U.S. Pub. No. 2019/0180949, titled “Supercapacitor,” published Aug. 29, 2017; U.S. Pat. No. 9,318,271, titled “High-Temperature Supercapacitor,” issued Apr. 19, 2016; U.S. Pub. No. 2020/0365336, titled “Energy Storage Device,” published Nov. 19, 2020; U.S. Pat. No. 9,233,860, titled “Supercapacitor and Method for Making the Same,” issued Jan. 12, 2016; and U.S. Pat. No. 9,053,870, titled “Supercapacitor with a Mesoporous Nanographene Electrode,” issued Jun. 9, 2015, all of which are incorporated herein by reference.

The supercapacitor adder module 104 may be small enough to fit into an existing battery compartment of the electric vehicle 120. The electric vehicle 120 may be any type of electric vehicle, non-limiting examples of which include automobiles, trucks, vans, fork lifts, carts (such as golf carts or baby carts), motorcycles, electric bikes scooters, autonomous vehicles, mobile robotic devices, hoverboards, monowheels, Segways®, wheelchairs, drones, personal aircraft, robotic devices, aquatic devices (such as boats, Jet Skis®, diver propulsion vehicles or underwater scooters), or the like.

The supercapacitor adder module 104 may be configured to easily connect to the electric vehicle 120 using standard battery connections 126 and may utilize circuitry including a first electrical path 122 and a second electrical path 124. The circuit layout of the first electrical path 122 and the second electrical path 124 is one example of how switching could occur, but there could be many others depending upon how the supercapacitor adder module 104 is designed. As illustrated in FIG. 1, the first electrical path 122 shows connections 126 between the electric vehicle 120 and electrochemical battery 102. The second electrical path 124 shows connections between electric vehicle 120 and a supercapacitor controller 108, which, in turn, is electrically coupled to the supercapacitor batteries 112 via internal circuitry (not shown). The connections 126 may be terminals (such as found in battery terminals) to connect the supercapacitor adder module 104 into the system 100. One or more of the connections 126 may include or be associated with a digitally controlled, high-powered relay to connect or disconnect the electrochemical battery 102 and/or the supercapacitor batteries 112 to or from the electric vehicle 120 by completing or interrupting the first electrical path 122 or the second electrical path 124, respectively. Suitable relays are available from TE Connectivity of Schaffhausen, Switzerland, among other suppliers.

There are many reasons to switch between the electrochemical battery 102 and supercapacitor batteries 112 (and vice versa) when powering the electric vehicle 120. For example, switching from the electrochemical battery 102 to the supercapacitor batteries 112 may allow the supercapacitor batteries 112 to run the electric vehicle 120 when higher amperage is desired quickly, such as when the electric vehicle 120 is moving up a steep hill or is predicted to move up the hill based on predefined or predicted route. In other examples, switching may be performed to optimize discharge, as the discharge is typically faster for the supercapacitor batteries 112 than the electrochemical battery 102.

In a further example, switching may be performed to enhance the long-term power storage of the electrochemical battery 102. For example, switching from the electrochemical battery 102 to the supercapacitor batteries 112 may be done to enhance the lifespan of the electrochemical battery 102, as the supercapacitor batteries 112 can be charged millions of times before they start to degrade, whereas the electrochemical battery 102 may only allow 500 to 1,000 charging cycles.

In some embodiments, a driving profile associated with the electric vehicle 120 may specify that supercapacitor batteries 112 are to be preferentially used to reduce charging cycles of the electrochemical battery 102 or otherwise reduce usage thereof to extend the useful life of the electrochemical battery 102. The driving profile may be specified by a user in some embodiments via a user interface (not shown) and stored in a memory for later retrieval.

In one embodiment, the supercapacitor adder module 104 further includes a switch and test module 106. The switch and test module 106 may include a current tester, which performs amperage measurement in the first electrical path 122 to determine how much amperage is drawn through the electrochemical battery 102 and the electric vehicle 120. The switch and test module 106 may also include a current tester in the second electrical path 124 to determine how much amperage is drawn through the through the supercapacitor batteries 112. As explained in greater detail below, the switch and test module 106 may also be instructed to disconnect or connect the electrochemical battery 102 using a digitally controlled, high-powered relay. The switch and test module 106 may operate in milliseconds, such that switching will not disrupt the smooth operation of the electric vehicle 120.

The supercapacitor adder module 104 may also include a supercapacitor controller 108 and a base module 116. As described in greater detail below, the supercapacitor controller 108 may switch between the electrochemical battery 102 and the supercapacitor batteries 112. For example, the supercapacitor controller 108 may disconnect the first electrical path 122 by instructing the switch and test module 106 to disconnect the first electrical path 122 and to switch the supercapacitor batteries 112 onto the second electrical path 124 using high-powered switching relays. The supercapacitor controller 108 also facilitates switching between the supercapacitor batteries 112 and the electrochemical battery 102 by disconnecting the second electrical path 124 and then instructing the switch and test module 106 to connect the first electrical path 122 allowing the electrochemical battery 102 onto the first electrical path 122 to power the electric vehicle 120.

As described in greater detail below, the supercapacitor controller 108 may also be controlled by a charger module 130, which may be a sub-module of the base module 116, when an external power source is connected to a charger 128 associated with the supercapacitor adder module 104.

The supercapacitor adder module 104 may include a controller 110, which may be embodied as a processor to execute instructions stored in a memory 114, such as a random-access memory or the like. The memory 114 may store the base module 116 described above, as well as various sub-modules, such as a charger module 130. The controller 110 may allow read/write access to a database 118, which may be stored and/or buffered by the memory 114. The controller 110 may further execute instructions to turn on and off the switch and test module 106 and supercapacitor controller 108.

The controller 110 also allows for current measurements from the first electrical path 122 and/or the second electrical path 124 to be collected and stored (in real-time) in the database 118. The controller 110 also controls the switching of the high-powered switching relay in the first electrical path 122 and the second electrical path 124 as the base module 116 executes. The controller 110 is also communicatively coupled with the charger 128 and charger module 130. The supercapacitor batteries 112 may be charged by an external power source that is connected to the charger 128.

The base module 116 reads the database 118 and then executes the switch and test module 106. The switch and test module 106 may determine if an electric vehicle 120 is connected and/or if the electrochemical battery 102 is connected. The switch and test module 106 also reads the current (amperage) through the first electrical path 122 when the electric vehicle 120 runs. The base module 116 controls the switch and test module 106 and measures amperage flowing through both paths 122, 124, which may be stored in the database 118. The base module 116 may then calculate an amperage use pattern using stored amperage data from the database 118.

The base module 116 may then determine if the amperage use pattern requires supercapacitor batteries 112. If so, the base module 116 executes the supercapacitor controller 108 to switch off the first electrical path 122 and turn on the second electrical path 124, connecting the supercapacitor batteries 112 through supercapacitor controller 108 to the electric vehicle 120. The base module 116 also determines if the amperage use patterns require switching from the supercapacitor batteries 112 back to the electrochemical battery 102. The base module 116 may also contain the charger module 130 that controls the operation of charger 128 when an external power source (not shown) is connected to the charger 128.

The database 118 allows reading and writing data from the base module 116 and their sub-modules and data associated with the switch and test module 106 and supercapacitor controller 108. The database 118 may also store the maximum charging energy or amperage for the supercapacitor batteries 112 based on manufacturer or user settings or recommendations. The supercapacitor adder module 104 can have many different supercapacitor batteries 112, so this charging data is useful for safety and performance.

The first electrical path 122 shows connections between electric vehicle 120 and the electrochemical battery 102, which is interrupted by the supercapacitor adder module 104. The second electrical path 124 shows connections between electric vehicle 120 and the supercapacitor controller 108, which allows the flow of charge from the supercapacitor batteries 112 to the electric vehicle 120. The connections 126 may include terminals (such as battery terminals) connecting the supercapacitor adder module 104 into the system 100.

The charger 128 is a hardware system that allows a physical connection to the external charging source. The charger 128 can be used to detect if the external charging source is connected. In one embodiment, when the external charging source is connected to the charger 128, the external charging source does not connect to any other connections 126 in the supercapacitor adder module 104 for safety reasons. If the external charging source is connected to the charger 128, the connections are controlled by the charger module 130. The charger module 130 manages the connection of the external charging source onto the charger 128 and allows the external charging source to first charge the supercapacitor batteries 112 and then the electrochemical battery 102. In other embodiments, the charger module 130 may first charge the electrochemical battery 102 and then the supercapacitor batteries or charge both the supercapacitor batteries 112 and the electrochemical battery 102 at the same time.

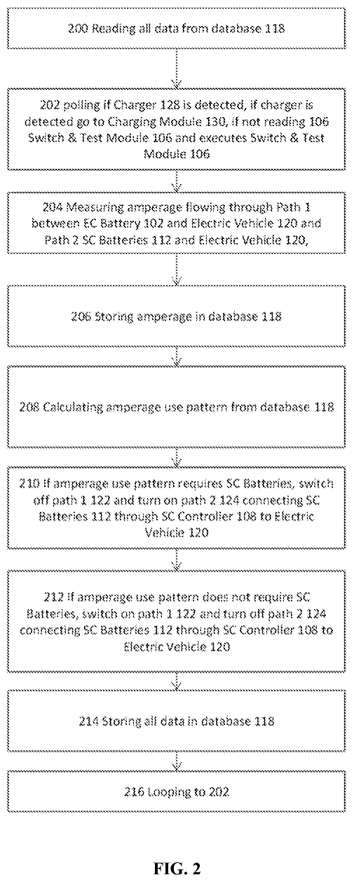

FIG. 2 is a flow chart of method performed by the base module 116. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

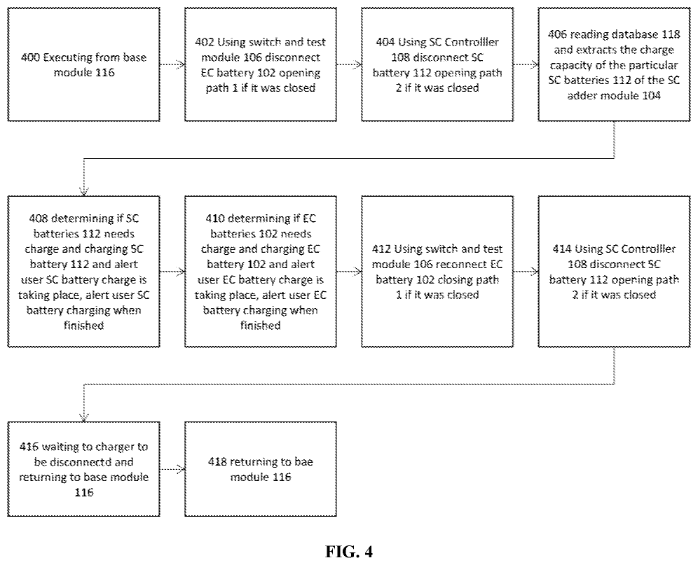

At step 200, the process begins with reading data from the database 118. At step 202, the base module 116 polls the charger 128 to determine whether the charger 128 connected to an external charging source. If so, control passes to the charger module 130, which is described with reference to FIG. 4. If the charger 128 is not so connected, the switch and test module 106 is executed and read to determine if an electric vehicle 120 is connected and/or if the electrochemical battery 102 is connected.

At step 204, the switch and test module 106, under control of the base module 116, measures the amperage passing through the first electrical path 122 (either inline or via a digital clamp meter) between the electrochemical battery 102 and the electric vehicle 120, as well as the amperage passing through the second electrical path 124 between the supercapacitor batteries 112 and the electric vehicle 120 when the electric vehicle 120 is running. At step 206, the switch and test module 106 stores amperage data and associated time stamps for the amperage data in the database 118. The time stamps are used, in one embodiment, to determine power usage at various times and for predicting power usage by the electric vehicle 120.

At step 208, the base module 116 then calculates an amperage use pattern from the database 118. The amperage use pattern for the electrochemical battery 102 may be the average amps used per hour. In some embodiments, the amperage use pattern of the electrochemical battery 102 could be the amperage data over time and/or compared to a threshold value or the amperage use pattern of an ideal or historical electrochemical battery 102 previously stored in the database 118. For example, the base module 116 may determine whether the amperage meets or exceeds a predefined, dynamic, and/or user-defined threshold value—or drops below a threshold value—which may be used as a condition to determine whether to switch between the electrochemical battery 102 and supercapacitor batteries 112 (or vice versa).

The prestored historical amperage use pattern may provide metadata that can be read to instruct the base module 116 to switch between the electrochemical battery 102 and supercapacitor batteries 112. In some embodiments, a switching threshold and its metadata may be prestored in the database 118. If the amperage is used, for example, at or above the switching threshold, the metadata would instruct the base module 116 to switch from the electrochemical battery 102 to the supercapacitor batteries 112.

At step 210, the base module 116 determines if the amperage use pattern requires supercapacitor batteries 112. If so, the base module 116 instructs the supercapacitor controller 108 to switch off the first electrical path 122 and turn on the second electrical path 124 connecting the supercapacitor batteries 112 through supercapacitor controller 108 to the electric vehicle 120. The base module 116 determines if amperage use patterns require an action to switch from electrochemical battery 102 to supercapacitor batteries 112 either by reading metadata from step 208 or by determining if amperage use data is beyond a preset threshold. It should be noted that the system 100 may be more intelligent by setting a threshold on amperage of supercapacitor batteries 112 to switch back to the electrochemical battery 102 if needed. It should also be noted there may also be hybrid switching by switching on both supercapacitor batteries 112 and electrochemical battery 102.

At step 212, the base module 116 determines if the amperage use pattern does not require supercapacitor batteries 112. If the amperage use pattern does not require supercapacitor batteries 112, the base module 116 instructs the supercapacitor controller 108 to switch on the first electrical path 122 and turn off the second electrical path 124 that connects the supercapacitor batteries 112 through supercapacitor controller 108 to electric vehicle 120. The base module 116 then stores all data in database 118 at step 214. At step 216, the base module 116 loops to step 202.

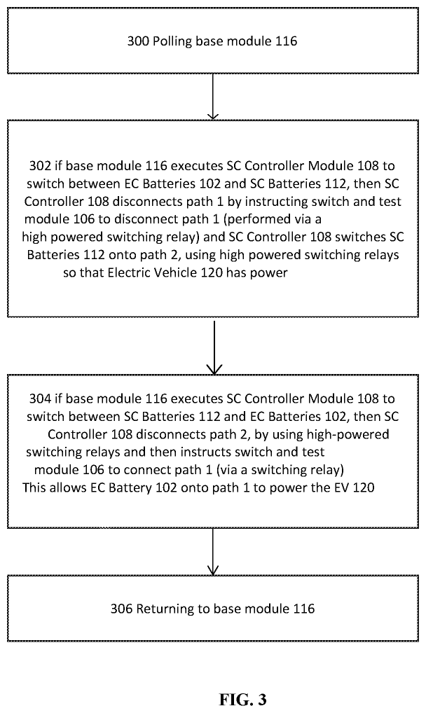

FIG. 3 is a flowchart of a method performed by the supercapacitor controller 108 in an embodiment. Those skilled in the art will appreciate that, for this and other processes and methods disclosed herein, the functions performed in the processes and methods may be implemented in a differing order. Furthermore, the outlined steps and operations are only provided as examples. Some of the steps and operations may be optional, combined into fewer steps and operations, or expanded into additional steps and operations without detracting from the essence of the disclosed embodiments.

The process begins with the supercapacitor controller 108 polling the base module 116 at step 300. At step 302, if the supercapacitor controller 108 determines whether the base module 116 executes the supercapacitor controller 108 to switch between the electrochemical battery 102 and the supercapacitor batteries 112. If so, the supercapacitor controller 108 disconnects the first electrical path 122 by instructing the switch and test module 106 to disconnect the first electrical path 122 via the high-powered switching relay and the supercapacitor controller 108 switches the supercapacitor batteries 112 onto the second electrical path 124 using the high-powered switching relays so that the electric vehicle 120 is powered by the supercapacitor batteries 112.

At step 304, if the supercapacitor controller 108 determines whether the base module 116 executes the supercapacitor controller 108 to switch between the supercapacitor batteries 112 and the electrochemical battery 102. If so, the supercapacitor controller 108 disconnects the second electrical path 124 using a high-powered switching relay and then instructs the switch and test module 106 to connect the first electrical path 122 via a high-powered switching relay. This allows the electrochemical battery 102 onto the first electrical path 122 so that electric vehicle 120 is powered by the electrochemical battery 102. The supercapacitor controller 108 then returns control to the base module 116 at step 306.

FIG. 4 is a flowchart of a method performed by the charger module 130. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

The process begins at step 400 with the charger module 130 being executed from the base module 116. At step 402, the charger module 130 uses the switch and test module 106 to disconnect the electrochemical battery 102, opening the first electrical path 122 if it was closed. In one embodiment, the external charging source (not shown), when connected to charger 128, is initially not connected to the electrochemical battery 102 or the supercapacitor batteries 112 for safety reasons.

At step 404, the charger module 130 uses the supercapacitor controller 108 to disconnect the supercapacitor batteries 112, opening the second electrical path 124 if it was closed. At step 406, the charger module 130 reads the database 118 and extracts the charge capacity of the particular supercapacitor batteries 112 of the supercapacitor adder module 104.

At step 408, the charger module 130 determines if the supercapacitor batteries 112 need to be charged, i.e., the supercapacitor batteries 112 are charged below their maximum capacity or a certain percentage of their maximum capacity. This is done, in one embodiment, by determining the maximum charge for the supercapacitor batteries 112 from the database 118. The external charging source is then connected through the charger 128 to the supercapacitor batteries 112. This is accomplished by high-powered relays associated with connections 126 4 and 5. In some embodiments, the current and/or the voltage are constantly monitored by test equipment internal to supercapacitor adder module 104. As the charge is directed to the supercapacitor batteries 112, it is monitored for voltage to ensure the maximum voltage (read from database 118) and maximum current (read from database 118) are reached and/or not exceeded. Once the maximums are reached (or a threshold percentage of the maximums), the charger module 130 disconnects the external charging source from the supercapacitor batteries 112.

In some embodiments, the charger module 130 generates an alert for the user to know that the supercapacitor batteries 112 are being charged and may also generate an alert when the charging of the supercapacitor batteries 112 is finished. The alerts may be accomplished via indicator lights on the supercapacitor adder module 104, user interface notifications in the electric vehicle 120, text messages to a mobile device, and/or the like.

At step 410, the charger module 130 determines if the electrochemical battery 102 need to be charged. The charger module 130 then charges the electrochemical battery 102 to its maximum charge or a certain threshold percentage of the maximum charge. In some embodiments, the charger module 130 alerts the user that charging of the electrochemical battery 102 is taking place using methods similar to those described above in connection with the supercapacitor batteries 112. The charger module 130 may also alert the user when charging of the electrochemical battery 102 is finished.

In one embodiment, high-powered relays take the connections of the external charging source (not shown) using charger connections 4 and 5 and connect them to connections 2 and 3, which has the effect of connecting the external charging source to the electrochemical batteries 102. The external charging source may have a controller and/or a battery charge management system to determine the electrochemical battery 102 type and level in some embodiments. As such, the external charging source may automatically control the correct, safe, high-performance charge. In this embodiment, the charger module 130 and/or the supercapacitor adder module 104 does not have to manage the electrochemical battery 102 charging directly. In other embodiments, the charger module 130 may obtain information about the maximum charge of the particular electrochemical battery 102 from the database 118 and manage the charging of the electrochemical battery 102. In some embodiments, the user can evaluate the charge on the electrochemical battery 102 by viewing a user interface associated with the external charging source.

The charger module 130 then disconnects the external charging source and alerts the user, through lights or other means, that the charging is complete. The external charging source is disconnected from supercapacitor adder module 104 and the user may be alerted to the disconnection.

At step 412, the charger module 130 uses the switch and test module 106 to reconnect the electrochemical battery 102, closing the first electrical path 122 if it was open. The charger module 130 then uses the supercapacitor controller 108 to disconnect the supercapacitor batteries 112, opening the second electrical path 124 if it was closed, at step 414. At step 416, the charger module 130 waits for the external charging source to be disconnected and returns to base module 116. The charger module 130 then returns to base module 116 at step 418.

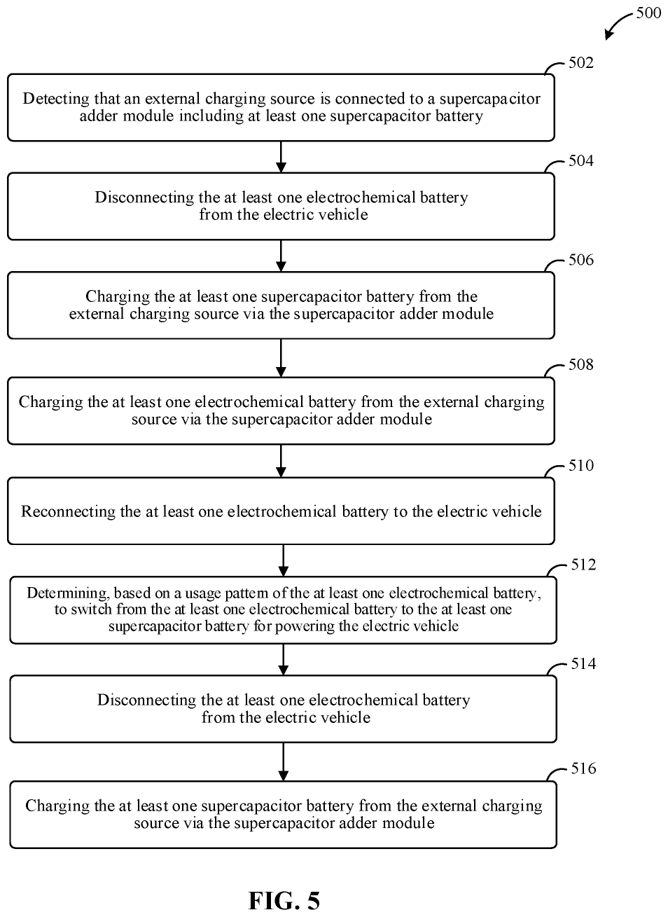

FIG. 5 is a flow chart of a method 500 for powering an electric vehicle 120 including at least one electrochemical battery 102 and a supercapacitor adder module 104 including at least one supercapacitor battery 112. The method 500 begins at step 502 with detecting that an external charging source is connected to the supercapacitor adder module 104. At step 504, the method 500 continues by disconnecting the at least one electrochemical battery 102 from the electric vehicle 120. At step 506, the method 500 continues by charging the at least one supercapacitor battery 112 from the external charging source via the supercapacitor adder module 104. At step 508, the method 500 continues by charging the at least one electrochemical battery 102 from the external charging source via the supercapacitor adder module 104. At step 510, the method 500 continues by reconnecting the at least one electrochemical battery 102 to the electric vehicle 120.

At step 512, the method 500 continues by determining, based on a usage pattern of the at least one electrochemical battery 102, to switch from the at least one electrochemical battery 102 to the at least one supercapacitor battery 112 for powering the electric vehicle 120. At step 514, the method 500 continues by disconnecting the at least one electrochemical battery 102 from the electric vehicle 120. At step 516, the method continues by connecting the at least one supercapacitor battery to power to the electric vehicle.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other types of medialmachine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

What is claimed is:

1. A method for powering an electric vehicle including at least one electrochemical battery and a supercapacitor adder module including at least one supercapacitor battery, the method comprising:
in response to detecting that an external charging source is connected to the supercapacitor adder module:
disconnecting the at least one electrochemical battery from the electric vehicle;
charging the at least one supercapacitor battery from the external charging source via the supercapacitor adder module;
charging the at least one electrochemical battery from the external charging source via the supercapacitor adder module; and
reconnecting the at least one electrochemical battery to the electric vehicle;
determining, based on a usage pattern of the at least one electrochemical battery, whether to switch from the at least one electrochemical battery to the at least one supercapacitor battery for powering the electric vehicle; and
in response to a determination to switch from the at least one electrochemical battery to the at least one supercapacitor battery:
disconnecting the at least one electrochemical battery from the electric vehicle; and
connecting the at least one supercapacitor battery to power to the electric vehicle.

2. The method of claim 1, wherein charging the at least one supercapacitor battery from the external charging source via the supercapacitor adder module comprises:
reading a database to determine a maximum capacity of the at least one supercapacitor battery;
connecting the external charging source to the at least one supercapacitor battery through a connection within the supercapacitor adder module; and
charging the at least one supercapacitor battery to at least a threshold percentage of the maximum capacity.

3. The method of claim 1, wherein charging the at least one supercapacitor battery from the external charging source via the supercapacitor adder module comprises sending an alert to a user that the at least one supercapacitor battery is being charged.

4. The method of claim 1, wherein charging the at least one supercapacitor battery from the external charging source via the supercapacitor adder module comprises sending an alert to a user that charging of the at least one supercapacitor battery is complete.

5. The method of claim 1, wherein charging the at least one electrochemical battery from the external charging source via the supercapacitor adder module comprises:
connecting the external charging source to the at least one electrochemical battery through a connection within the supercapacitor adder module; and
allowing a battery management system of the external charging source to charge the at least one electrochemical battery.

6. The method of claim 1, wherein charging the at least one supercapacitor battery takes place before charging the at least one electrochemical battery.

7. The method of claim 1, wherein determining, based on the usage pattern of the at least one electrochemical battery, whether to switch from the at least one electrochemical battery to the at least one supercapacitor battery for powering the electric vehicle comprises:
measuring, by at least one current tester, current flow between the at least one electrochemical battery and the electric vehicle;
storing indications of the current flow in a database; and
using the indications of the current flow in the database to determine the usage pattern.

8. The method of claim 7, wherein the usage pattern includes the current flow either meeting or exceeding a threshold value.

9. The method of claim 1, further comprising:
determining, based on a usage pattern of the at least one supercapacitor battery, whether to switch from the at least one supercapacitor battery to the at least one electrochemical battery for powering the electric vehicle; and
in response to a determination to switch from the at least one supercapacitor battery to the at least one electrochemical battery:
disconnecting the at least one supercapacitor battery from the electric vehicle; and
connecting the at least one electrochemical battery to power the electric vehicle.

10. The method of claim 9, wherein determining, based on the usage pattern of the at least one supercapacitor battery, whether to switch from the at least one supercapacitor battery to the at least one electrochemical battery for powering the electric vehicle comprises:
measuring, by at least one current tester, current flow between the at least one supercapacitor battery and the electric vehicle;
storing indications of the current flow in a database; and
using the indications of the current flow in the database to determine the usage pattern.

11. A system for powering an electric vehicle, the system comprising:
at least one electrochemical battery;
supercapacitor adder module including at least one supercapacitor battery; and
a controller configured, in response to detecting that an external charging source is connected to the supercapacitor adder module, to:
disconnect the at least one electrochemical battery from the electric vehicle;
charge the at least one supercapacitor battery from the external charging source via the supercapacitor adder module;
charge the at least one electrochemical battery from the external charging source via the supercapacitor adder module; and
reconnect the at least one electrochemical battery to the electric vehicle;
wherein the controller is further configured to determine, based on a usage pattern of the at least one electrochemical battery, whether to switch from the at least one electrochemical battery to the at least one supercapacitor battery for powering the electric vehicle and, in response to a determination to switch from the at least one electrochemical battery to the at least one supercapacitor battery:
disconnect the at least one electrochemical battery from the electric vehicle; and
connect the at least one supercapacitor battery to power to the electric vehicle.

12. The system of claim 11, wherein the controller, when charging the at least one supercapacitor battery from the external charging source via the supercapacitor adder module, is configured to:
read a database to determine a maximum capacity of the at least one supercapacitor battery;
connect the external charging source to the at least one supercapacitor battery through a connection within the supercapacitor adder module; and
charge the at least one supercapacitor battery to at least a threshold percentage of the maximum capacity.

13. The system of claim 11, wherein the controller, when charging the at least one supercapacitor battery from the external charging source via the supercapacitor adder module, is configured to send an alert to a user that the at least one supercapacitor battery is being charged.

14. The system of claim 11, wherein the controller, when charging the at least one supercapacitor battery from the external charging source via the supercapacitor adder module, is configured to send an alert to a user that charging of the at least one supercapacitor battery is complete.

15. The system of claim 11, wherein the controller, when charging the at least one electrochemical battery from the external charging source via the supercapacitor adder module, is configured to:
connect the external charging source to the at least one electrochemical battery through a connection within the supercapacitor adder module; and
allow a battery management system of the external charging source to charge the at least one electrochemical battery.

16. The system of claim 11, wherein charging of the at least one supercapacitor battery takes place before charging the at least one electrochemical battery.

17. The system of claim 11, wherein the controller, when determining, based on the usage pattern of the at least one electrochemical battery, whether to switch from the at least one electrochemical battery to the at least one supercapacitor battery for powering the electric vehicle, is configured to:
measure, by at least one current tester, a current flow between the at least one electrochemical battery and the electric vehicle;
store indications of the current flow in a database; and
use the indications of the current flow in the database to determine the usage pattern.

18. The system of claim 17, wherein the usage pattern includes the current flow either meeting or exceeding a threshold value.

19. The system of claim 11, wherein the controller is further configured to:
determine, based on a usage pattern of the at least one supercapacitor battery, whether to switch from the at least one supercapacitor battery to the at least one electrochemical battery for powering the electric vehicle; and
in response to a determination to switch from the at least one supercapacitor battery to the at least one electrochemical battery:
disconnect the at least one supercapacitor battery from the electric vehicle; and
connect the at least one electrochemical battery to power the electric vehicle.

20. The system of claim 19, wherein the controller, when determining, based on the usage pattern of the at least one supercapacitor battery, whether to switch from the at least one supercapacitor battery to the at least one electrochemical battery for powering the electric vehicle comprises, is configured to:
measure, by at least one current tester, current flow between the at least one supercapacitor battery and the electric vehicle;
store indications of the current flow in a database; and
use the indications of the current flow in the database to determine the usage pattern.
